(19) United States
(12) Patent Application Publication
(10) Pub. No.: US 2025/0044738 A1
(43) Pub. Date: Feb. 6, 2025

(54) HOLOGRAPHIC PRINTER USING VIBRATION-FREE MECHANICAL SHUTTER

(71) Applicant: Korea Electronics Technology Institute, Seongnam-si (KR)

(72) Inventors: Sung Hee HONG, Seoul (KR); Young Min KIM, Seoul (KR); Ji Soo HONG, Seoul (KR)

(73) Assignee: Korea Electronics Technology Institute, Seongnam-si (KR)

(21) Appl. No.: 18/713,782

(22) PCT Filed: Dec. 6, 2021
(86) PCT No.: PCT/KR2021/018318

§ 371 Date: May 28, 2024

(30) Foreign Application Priority Data
Dec. 6, 2021 (KR) 10-2021-0172558

(51) Int. Cl. G03H 1/04

(52) U.S. Cl. CPC G03H 1/0476; G03H 2001/048

(57) ABSTRACT

A holographic printer using a vibration-free mechanical shutter is provided. A holographic printer, according to an embodiment of the present invention, comprises: a light source which emits light; a modulator which modulates the light emitted from the light source to generate a holographic fringe pattern in a hogel unit; a stage on which a holographic recording medium, on which a holographic fringe pattern generated by the modulator is to be recorded in a hogel unit, is placed; a driving part which moves a position of the stage in a hogel unit; and a shutter which periodically exposes, to the holographic recording medium, object light generated by the holographic fringe pattern generated by the modulator, wherein the shutter includes a rotating plate having a slit that exposes the object light by means of the holographic fringe pattern, and a motor rotating the rotating plate. Accordingly, by applying a mechanical shutter having a structure in which vibration does not occur to the holographic printer, it is possible to prevent degradation of hologram recording quality caused by vibration generated during opening/closing of the shutter.

### TECHNICAL FIELD

The disclosure relates to a holographic printer, and more particularly, to a holographic printer which records a hologram on a hologram recording medium on a hogel basis.

### BACKGROUND ART

FIG. 1 is a view illustrating a hologram recording process of a holographic printer. A hologram may be recorded in the unit of a hogel, which is a part obtained by dividing a hologram in a grid pattern. A hogel of a hologram may be understood as a concept corresponding to a pixel of an image.

The process illustrated in FIG. 1 is a process of recording one hogel. As shown in the drawing, a stage on which a hologram recording medium on which a hologram is to be recorded is placed may be moved and stopped, and then, a hologram image of a corresponding hogel may be uploaded and a hologram corresponding to the hogel may be recorded on the hologram recording medium by operating (opening)/stopping (closing) a shutter.

FIG. 2 is a view illustrating a shutter of a holographic printer. The shutter used in the holographic printer may be a mechanical shutter, and switches between an open state and a closed state as shown in the drawing. However, a vibration may be accompanied when the shutter is opened (shutter-on) and closed (shutter-off) as shown in FIG. 3.

However, a holographic printer may be vulnerable to a vibration and thus a vibration of a shutter may degrade hologram recording quality.

### DISCLOSURE

### Technical Problem

The disclosure has been developed in order to address the above-discussed deficiencies of the prior art, and an object of the disclosure is to provide a holographic printer using a vibration-free mechanical shutter as a solution to prevent hologram recording quality from being degraded by a vibration generated in the process of opening/closing the shutter.

### Technical Solution

According to an embodiment of the disclosure to achieve the above-described object, a holographic printer may include: a light source configured to emit light; a modulator configured to generate a holographic fringe pattern on a hogel basis by modulating light emitted from the light source; a stage on which a hologram recording medium is placed, the holographic fringe pattern generated by the modulator being recorded on the hologram recording medium on a hogel basis; a driver configured to move a position of the stage on a hogel basis; and a shutter configured to periodically expose object light generated by the holographic fringe pattern generated by the modulator to the hologram recording medium, and the shutter may include: a rotation plate on which a slit is formed to expose the object light generated by the holographic fringe pattern; and a motor configured to rotate the rotation plate.

In addition, the rotation plate may have a circular shape. The slit may have a hogel shape.

According to an embodiment of the disclosure, the holographic printer may further include a controller configured to control a speed of the motor to control an exposure period of the shutter.

A plurality of slits may be formed on the rotation plate. The number of slits may be determined by an exposure period of the shutter.

An exposure period of the shutter may be calculated by the following equation:

$$\frac{1}{P \times ( \frac{360}{N} )}$$

wherein P is the number of rotations per unit time of the motor, and N is an angle between adjacent slits.

According to another embodiment of the disclosure, a hologram recording method may include: a step of emitting light; a step of generating a holographic fringe pattern on a hogel basis by modulating emitted light; a step of moving a position of a stage on which a hologram recording medium is placed on a hogel basis, the generated holographic fringe pattern being recorded on the hologram recording medium on a hogel basis; and a step of periodically exposing object light generated by the generated holographic fringe pattern to the hologram recording medium by using a shutter, and the shutter may include: a rotation plate on which a slit is formed to expose the object light generated by the holographic fringe pattern; and a motor configured to rotate the rotation plate.

### Advantageous Effects

As described above, according to embodiments of the disclosure, a vibration-free mechanical shutter may be applied to a holographic printer, so that hologram recording quality may be prevented from being degraded by a vibration generated in the process of opening/closing a shutter.

According to embodiments of the disclosure, by increasing a rotation speed of a motor and the number of slits formed on a rotation plate, an exposure period of a shutter may be set to be very short, and limits to an exposure period of a related-art mechanical shutter may be overcome.

### DESCRIPTION OF DRAWINGS

FIG. 1 is a view illustrating a hologram recording process of a holographic printer;

FIG. 2 is a view illustrating a shutter of a holographic printer;

FIG. 3 is a view illustrating a vibration accompanied by opening/closing of a shutter;

FIG. 4 is a view illustrating a structure of a holographic printer according to an embodiment of the disclosure;

FIG. 5 is a view illustrating a detailed structure of a shutter;

FIG. 6 is a view illustrating an example of a shutter of a structure different from that of FIG. 5; and

FIG. 7 is a view for explaining calculation of an exposure period of a shutter.

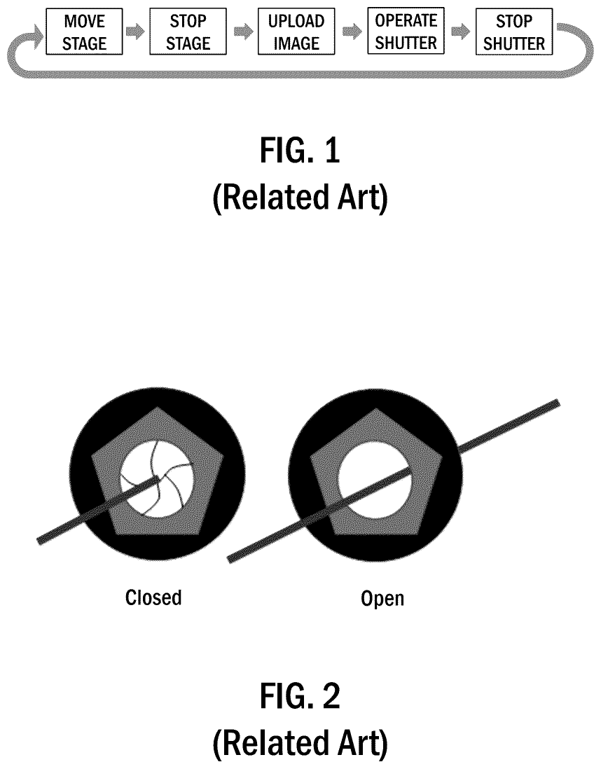

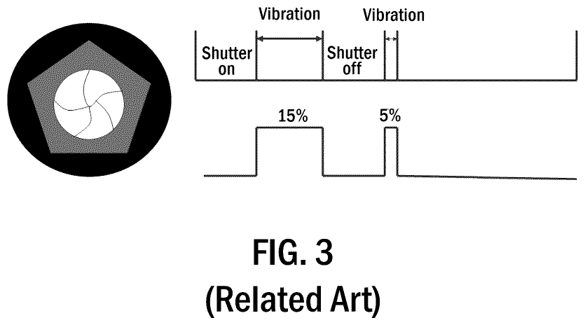

### BEST MODE

Hereinafter, the disclosure will be described in more detail with reference to the drawings.

Embodiments of the disclosure provide a holographic printer using a vibration-free mechanical shutter.

Specifically, the disclosure relates to a holographic printer which uses a shutter that is operated by rotating a rotation plate having a slit formed thereon and exposing object light generated by a holographic fringe pattern to a hologram recording medium, rather than using a shutter operated by opening and closing. Accordingly, a vibration caused by opening and closing may be removed, so that hologram recording quality may be enhanced.

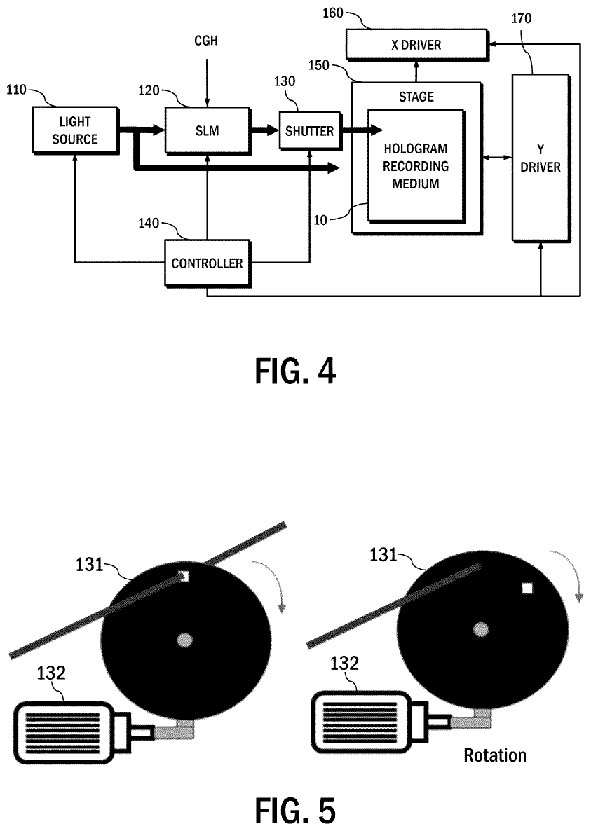

FIG. 4 is a view illustrating a structure of a holographic printer according to an embodiment of the disclosure. The holographic printer according to an embodiment of the disclosure may include a light source 110, a spatial light modulator (SLM) 120, a shutter 130, a controller 140, a stage 150, an X-driver 160 and a Y-driver 170 as shown in the drawing.

The light source 110 emits light which is used for generating object light and reference light required to generate a hologram. The light source 110 may be implemented by a laser light source.

Light emitted from the light source 110 may be split by a beam splitter (not shown), such that a part of the light is applied to the SLM 120 and the other part of the light enters a hologram recording medium 10 through an optical system as reference light.

The SLM 120 may generate a holographic fringe pattern by modulating light entering from the light source 110, based on a computer generated hologram (CGH) generated by a hologram generation system (not shown) which is a computing system.

The holographic fringe pattern is generated at the SLM 120 on a hogel basis. Accordingly, a CGH image may be generated at the hologram generation system on a hogel basis and may be applied to the SLM 120 on a hogel basis.

The shutter 130 may periodically switch between an open state and a closed state to periodically expose object light generated by the holographic fringe pattern generated at the SLM 120 to the hologram recording medium 10.

While the shutter 130 is open, a hologram which is an interference fringe of object light generated by the holographic fringe pattern and reference light generated by a part of light split from the light source 110 may be recorded on a corresponding hogel area of the hologram recording medium 10.

The hologram recording medium 10 may be placed on the stage 150, and the X-driver 160 and the Y-driver 170 may move the stage 150 in X-axis and Y-axis directions to allow a hologram to be recorded on the hologram recording medium 10 on a hogel basis.

The controller 140 may control turning on/off of the light source 110, a modulating operation of the SLM 120, a period and a speed of the shutter 130, and movement of the stage 150 by the X-driver 160 and the Y-driver 170.

FIG. 5 is a view illustrating a detailed structure of the shutter 130. The shutter 130 may include a rotation plate 131 and a servo motor 132 as shown in the drawing. The left view of FIG. 5 shows an open state of the shutter 130 and the right view shows a closed state of the shutter 130.

The rotation plate 131 may be a circular plate that has a slit formed on an upper portion thereof to expose object light generated by a holographic fringe pattern generated by the SLM 120 to the hologram recording medium 10.

The slit formed on the rotation plate 131 may be implemented in the same shape as a hogel shape or in other shapes.

The servo motor 132 may be configured to rotate the rotation plate 131 at a uniform velocity. The controller 140 may control a rotation speed of the servo motor 132 to control an exposure period of the shutter 130.

Specifically, when the rotation speed of the servo motor 132 increases, the exposure period of the shutter 130 may become shorter, and, when the rotation speed of the servo motor 132 decreases, the exposure period of the shutter 130 may become longer.

Since the servo motor 132 does not almost generate a vibration when rotating, a vibration does not occur when the shutter 130 switches between an open state and a closed state as shown in FIG. 5.

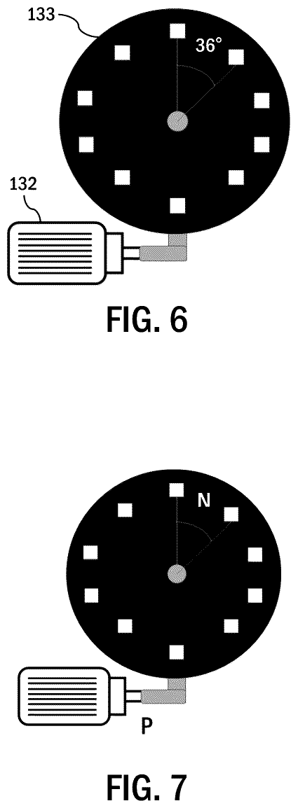

FIG. 6 illustrates a shutter 130 of a structure different from that of FIG. 5. The shutter 130 of FIG. 6 is different from the shutter of FIG. 5 having the rotation plate 131 having one slit formed thereon in that 10 slits are formed on a rotation plate 133.

The number of slits formed on the rotation plate 133 may be other number than 10 shown in FIG. 6.

On the assumption that the rotation speed of the servo motor 132 is the same, if the number of slits of the rotation plate 133 increases, the exposure period of the shutter 130 may become shorter, and, if the number of slits of the servo motor 132 decreases, the exposure period of the shutter 130 may become longer.

Accordingly, the number of slits formed on the rotation plate 133 may be determined according to the exposure period of the shutter 130.

The exposure period of the shutter 130 may be calculated based on the following equation:

$$\frac{1}{P \times ( \frac{360}{N} )}$$

where P is the number of rotations per unit time of the motor, and N is an angle between adjacent slits (see FIG. 7).

As shown in FIG. 6, if 10 slits are formed on the rotation plate 133 at an angle of 36 degrees and the number of rotations of the servo motor 132 is 1 hz, the exposure period of the shutter 130, that is, a time interval during which the shutter 130 is open may be 1/10 s according to the above-described equation.

Up to now, a holographic printer using a vibration-free mechanical shutter has been described with reference to preferred embodiments.

An embodiment of the disclosure proposes a structure which rotates a rotation plate having a slit formed thereon through a servo motor and periodically exposes object light generated by a holographic fringe pattern to a hologram recording medium in order to remove a vibration which may be generated by a related-art mechanical shutter.

An exposure period may be adjusted by adjusting a rotation speed of the servo motor and the number of slits of the rotation plate, and only one of the rotation speed and the number of slits may be adjusted or both of them may be adjusted.

In the above-described embodiment, hologram recording equality may be prevented from being degraded by a vibration generated in the process of opening/closing a shutter, and an exposure period of the shutter may be set to be very short by increasing the rotation speed of a motor and the number of slits formed on a rotation plate.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A holographic printer comprising:
a light source configured to emit light;
a modulator configured to generate a holographic fringe pattern on a hogel basis by modulating light emitted from the light source;
a stage on which a hologram recording medium is placed, the holographic fringe pattern generated by the modulator being recorded on the hologram recording medium on a hogel basis;
a driver configured to move a position of the stage on a hogel basis; and
a shutter configured to periodically expose object light generated by the holographic fringe pattern generated by the modulator to the hologram recording medium,
wherein the shutter comprises: a rotation plate on which a slit is formed to expose the object light generated by the holographic fringe pattern; and a motor configured to rotate the rotation plate.

2. The holographic printer of claim 1, wherein the rotation plate has a circular shape.

3. The holographic printer of claim 1, wherein the slit has a hogel shape.

4. The holographic printer of claim 1, further comprising a controller configured to control a speed of the motor to control an exposure period of the shutter.

5. The holographic printer of claim 1, wherein a plurality of slits are formed on the rotation plate.

6. The holographic printer of claim 5, wherein the number of slits is determined by an exposure period of the shutter.

7. The holographic printer of claim 5, wherein an exposure period of the shutter is calculated by the following equation:
$$\frac{1}{P \times ( \frac{360}{N} )}$$
wherein P is the number of rotations per unit time of the motor, and N is an angle between adjacent slits.

8. A hologram recording method comprising:
a step of emitting light;
a step of generating a holographic fringe pattern on a hogel basis by modulating emitted light;
a step of moving a position of a stage on which a hologram recording medium is placed on a hogel basis, the generated holographic fringe pattern being recorded on the hologram recording medium on a hogel basis; and
a step of periodically exposing object light generated by the generated holographic fringe pattern to the hologram recording medium by using a shutter,
wherein the shutter comprises: a rotation plate on which a slit is formed to expose the object light generated by the holographic fringe pattern; and a motor configured to rotate the rotation plate.
